(19) United States
(12) Patent Application Publication
(10) Pub. No.: US 2019/0211861 A1
(43) Pub. Date: Jul. 11, 2019

(54) Screw Apparatus

(71) Applicant: Sheng Yang International Technology Co., Ltd., New Taipei City (TW)

(72) Inventor: Jen-Chuan Ku, New Taipei City (TW)

(21) Appl. No.: 15/863,981

(22) Filed: Jan. 8, 2018

(51) Int. Cl. F16B 13/06

(52) U.S. Cl. CPC F16B 13/066

(57) ABSTRACT

A screw apparatus includes a shaft unit fastened inside a sleeve unit. The shaft unit includes a first end portion and a second end portion of a tapered shape. An outer diameter of the second end portion is greater than that of the first end portion. The sleeve unit comprises a holding portion, a locking portion and an expansion portion. The holding portion is attached onto the locking portion. An outer diameter of the holding portion is greater than that of the locking portion. The sleeve unit is locked onto an object with the locking members. A fastening unit is fastened onto the first end portion of the shaft unit to allow the second end portion thereof to move toward the expansion portion of the sleeve unit; thereby, the second end portion forces the expansion portion to expand outward in order to secure the sleeve unit onto the object.

### (a) TECHNICAL FIELD OF THE INVENTION

The present invention is related to a screw, in particular, to an expansion screw capable of being installed into a pre-drilled preparatory hole on a wall surface.

### (b) DESCRIPTION OF THE PRIOR ART

Presently, it is known that a conventional expansion screw mainly comprises a sleeve, a screw shaft for penetrating into the sleeve and a nut fastened on the screw shaft. The edge of the screw shaft is formed of an expanded end portion. After the screw shaft penetrates into a preparatory hole pre-drilled on a wall, the nut can be rotated to allow the screw shaft to move outward, and the expanded end portion of the screw shaft is able to expand the bottom end of the sleeve in order to be abutted against the internal of the preparatory hole such that the expansion screw can be secured inside the preparatory hole.

However, before the use of the aforementioned expansion screw, it is necessary to pre-drill the preparatory hole at the desired fastening location by using the tool of an electrical drill etc. In addition, the hole diameter of the preparatory hole needs to match with the outer diameter and length of the expansion screw such that the size thereof cannot be too large or too small. As a result, the installation process of such conventional expansion screw can be tedious and time consuming.

Furthermore, since the drill head is required to perform the drilling operation, it is constantly worn out and may become slim in size overtime. Consequently, in actual operations, the drill head needs to be replaced with new ones from time to time in order to prevent unfit hole diameter of the preparatory hole such that the expansion screw cannot be inserted into the hole or may be jammed inside the preparatory hole.

Finally, to place the expansion screw into the preparatory hole, hammer or rigid object is often required for impacting the expansion screw in order to allow the expansion screw to be completely inserted into the preparatory hole. Nevertheless, the situation of erroneous angles of impact due to difficulties of hammering often occurs, leading to unstable or incomplete installation process.

In view of the above, there is a need to overcome the aforementioned drawbacks. Accordingly, the inventor seeks to resolve the technical difficulties and successfully completes the novel design of the present invention with advantageous technical effects after years of researches and developments along with extensive experience in relevant fields and industries.

### SUMMARY OF THE INVENTION

In view of the aforementioned drawbacks, the present invention provides a screw apparatus comprising a shaft unit and a sleeve unit. The shaft unit is fastened at the internal of the sleeve unit. The shaft unit includes a first end portion and a second end portion. The second end portion is of a tapered shape such that an outer diameter of the second end portion is greater than an outer diameter of the first end portion. The sleeve unit comprises a holding portion, a locking portion and an expansion portion. The holding portion is attached onto one side of the locking portion opposite thereto. An outer diameter of the holding portion is configured to be greater than an outer diameter of the locking portion. An outer side of the locking portion includes a plurality of locking members formed to circumference thereon. The locking portion and the expansion portion are integrally formed as one piece. The expansion portion includes a plurality of slots formed thereon, and each one of the slots extends to an end surface of the expansion portion. The shaft unit is fastened onto the inner threaded portion of the sleeve unit via the outer threaded portion thereof. The sleeve unit is configured to lock onto an internal of an object via the locking members. In addition, the screw apparatus of the present invention also comprises a fastening unit, which is fastened onto the first end portion of the shaft unit in order to allow the second end portion of the shaft unit to move toward the expansion portion of the sleeve unit; thereby, the second end portion forces the expansion portion to expand outward in order to secure the sleeve unit inside the object.

The primary objective of the screw apparatus of the present invention relies in that: the outer side of the sleeve unit is formed of outer threads such that the sleeve unit is able to attach onto the object more firmly and stably.

### BRIEF DESCRIPTION OF THE DRAWINGS

FIG. 1 is a perspective view of the first exemplary embodiment of the screw apparatus of the present invention;

FIG. 2 is a perspective exploded view of the first exemplary embodiment of the screw apparatus of the present invention;

FIG. 3 is a cross sectional view of the first exemplary embodiment of the screw apparatus of the present invention;

FIG. 4 is a cross sectional view of the first exemplary embodiment of the screw apparatus of the present invention as shown in FIG. 3 under a state of use; and

FIG. 5 is a perspective view of a second exemplary embodiment of the screw apparatus of the present invention.

### DETAILED DESCRIPTION OF THE PREFERRED EMBODIMENTS

To facilitate the understanding of the technical features and the technical effects of the present invention, the following provides a detailed description of exemplary embodiments of the present invention along with the accompanied drawings.

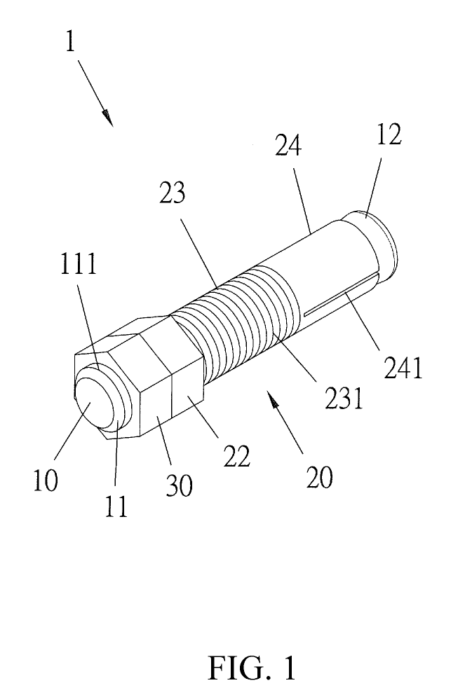

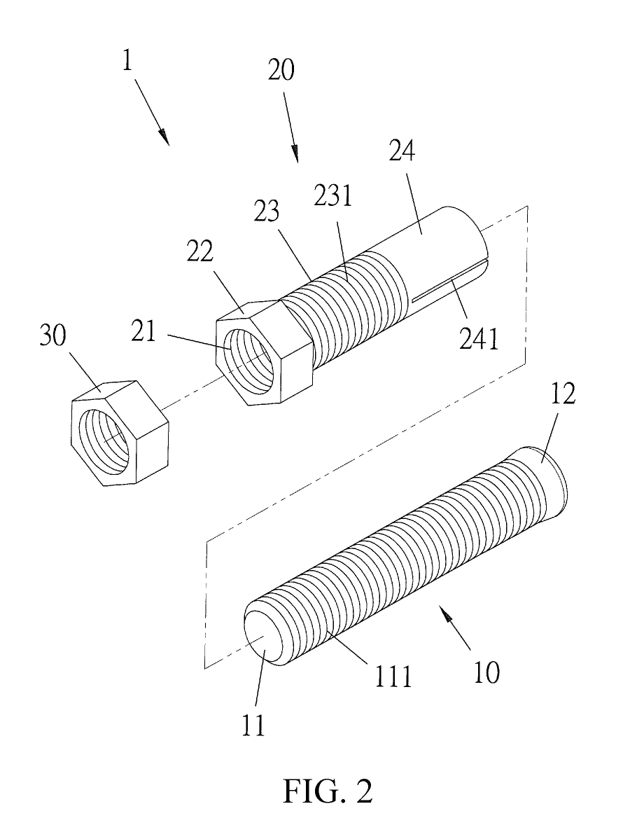

Please refer to FIG. 1 and FIG. 2, showing a screw apparatus 1 according to a first exemplary embodiment of the present invention. The screw apparatus comprises a shaft unit 10, a sleeve unit 20 and a fastening unit 30. The following provides further details of each unit respectively.

The shaft unit 10 includes a first end portion 11 and a second end portion 12. An outer side of the first end portion 11 includes an outer threaded portion 111 formed to circumference thereon. The second end portion 12 is of a tapered shape such that an outer diameter of the second end portion 12 is greater than an outer diameter of the first end portion 11.

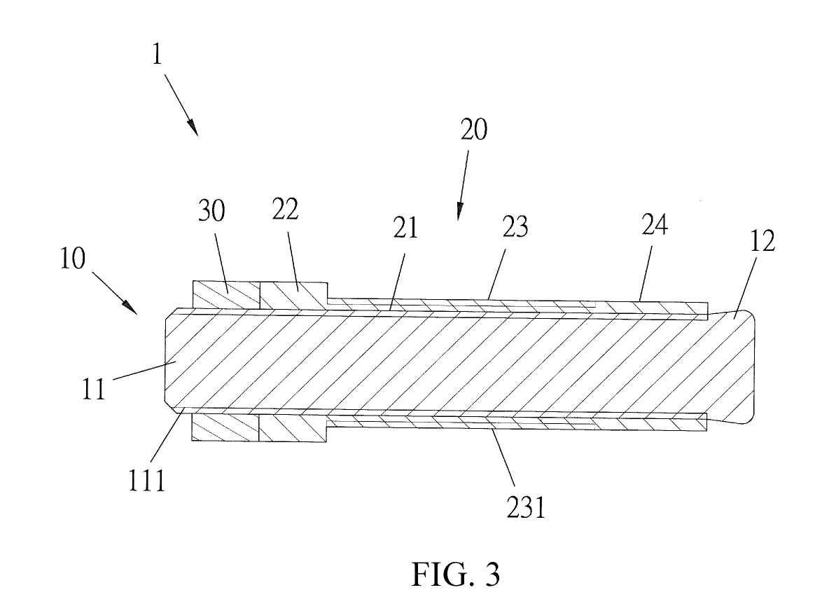

As shown in FIG. 1 to FIG. 3, the sleeve unit 20 includes an inner threaded portion 21 formed at an internal thereof, which is provided for fastening onto the outer threaded portion 111 of the shaft unit 10. In addition, the two ends of the sleeve unit 20 are connected to the external thereof. The sleeve unit 20 comprises a holding portion 22, a locking portion 23 and an expansion portion 24. The holding portion 22 is attached onto one side of the locking portion 23 opposite thereto. In this exemplary embodiment of the present invention, the holding portion 22 is of a polygonal shape; however, the present invention is not limited to such shape only.

The outer diameter of the holding portion 22 is greater than the outer diameter of locking portion 23. An outer side of the locking portion 23 includes a plurality of locking members 231 formed to circumference thereon. In this exemplary embodiment, the locking members 231 are outer threads; however, the present invention is not limited to such configuration only.

The locking portion 23 and the expansion portion 24 are integrally formed as one piece. The expansion portion 23 includes a plurality of slots 241 formed thereon, and each one of the slots 241 extends to the end surface of the expansion portion 24. The shaft unit 10 is fastened onto the inner threaded portion 21 of the sleeve unit 20 via the outer threaded unit 111 thereof. The sleeve unit 20 is locked onto an internal of an object (not shown in the drawings) via the locking member 231; wherein the object can be a wall, cabinet or door plank etc.; however, the present invention is not limited to such objects only, and the user can install the screw apparatus onto any objects according to his or her needs.

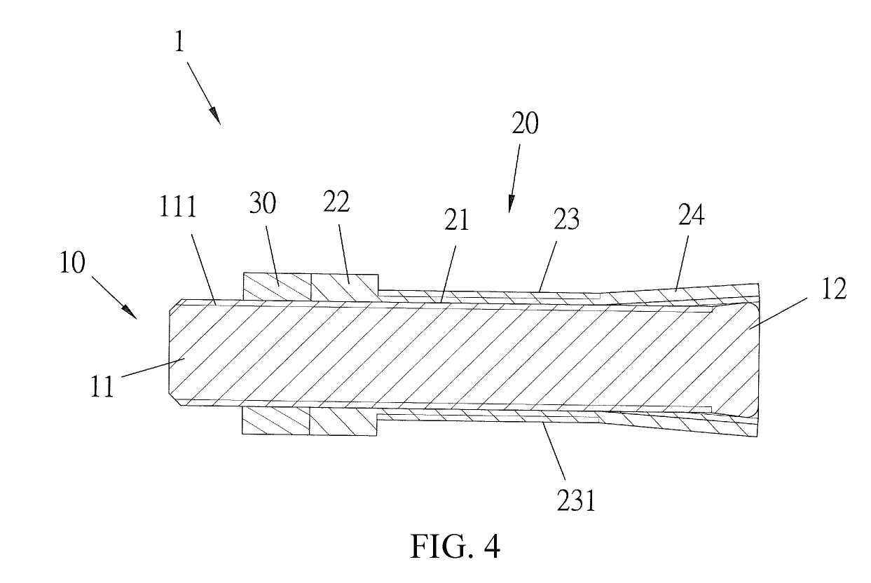

As shown in FIG. 1 to FIG. 4, the fastening unit 30 is fastened onto the first end portion 11 of the shaft unit 10 in order to allow the second end portion 12 of the shaft unit 10 to move toward the expansion portion 24 of the sleeve unit 20. With the tapered structure of the second end portion 12, the second end portion 12 is able to push the expansion portion 24 to expand outward along the slots 241 such that the sleeve unit 20 can be secured inside the object. In this exemplary embodiment, the fastening unit 20 is a nut; however, the present invention is not limited to such configuration only.

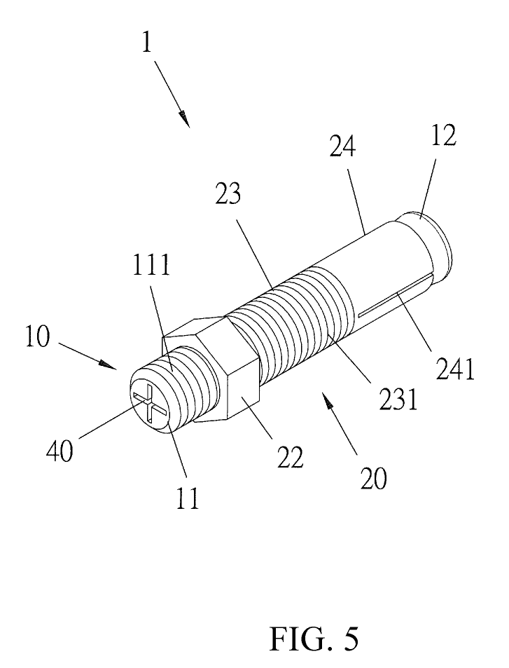

Please refer to FIG. 5, showing a screw apparatus according to a second exemplary embodiment of the present invention. Since the main elements and structure of the second exemplary embodiment are identical to the ones of the first exemplary embodiment previously mentioned, the description of such identical parts are omitted hereafter.

In the screw apparatus according to the second exemplary embodiment of the present invention, the shaft unit 10 is fastened inside the sleeve unit 20, and the sleeve unit 20 uses the locking member 231 for locking onto an object (not shown in the drawings). The end surface of the first end portion 11 of the shaft unit 10 is formed of a flat-shape slot or a cross-shape slot 40 thereon. As shown in FIG. 5, the cross-shape slot 40 is shown on the screw apparatus of the present invention for illustrative purpose only. In addition, a tool (not shown in the drawings), such as a cross-head screwdriver in this exemplary embodiment, can be used to fit with the cross-shape slot 40 in order to rotate the shaft unit 10; thereby, the second end portion 12 can be driven to move toward the expansion portion 24 of the sleeve unit 20, and the second end portion 12 is able to force the expansion portion 24 to expand outward such that the sleeve unit 20 can be secured inside the object.

I claim:

1. A screw apparatus, comprising:
a shaft unit having a first end portion and a second end portion; an outer side of the first end portion having an outer threaded portion formed to circumference thereon; the second end portion having a tapered shape such that an outer diameter of the second end portion is greater than an outer diameter of the first end portion;
a sleeve unit having an inner threaded portion formed at an internal thereof and two ends connected to an external; the sleeve unit further comprising a holding portion, a locking portion and an expansion portion; the holding portion attached onto one side of the locking portion opposite thereto; an outer diameter of the holding portion configured to be greater than an outer diameter of the locking portion;
an outer side of the locking portion having a plurality of locking members formed to circumference thereon; the locking portion and the expansion portion integrally formed as one piece; the expansion portion having a plurality of slots; each one of the slots extended to an end surface of the expansion portion; the shaft unit being fastened onto the inner threaded portion of the sleeve unit via the outer threaded portion thereof; the sleeve unit configured to lock onto an internal of an object via the locking members; and
a fastening unit fastened onto the first end portion of the shaft unit in order to allow the second end portion of the shaft unit to move toward the expansion portion of the sleeve unit; thereby, the second end portion forces the expansion portion to expand outward in order to secure the sleeve unit inside the object.

2. The screw apparatus according to claim 1, wherein the holding portion of the sleeve unit is of a polygonal shape.

3. The screw apparatus according to claim 1, wherein the plurality of locking members of the sleeve unit are outer threads.

4. The screw apparatus according to claim 1, wherein the fastening unit is a nut.

5. A screw apparatus, comprising:
a shaft unit having a first end portion and a second end portion; an outer side of the first end portion having an outer threaded portion formed to circumference thereon; the second end portion having a tapered shape such that an outer diameter of the second end portion is greater than an outer diameter of the first end portion; an end surface of the first end portion having a flat-shape slot or a cross-shape slot formed thereon;
a sleeve unit having an inner threaded portion formed at an internal thereof and two ends connected to an external; the sleeve unit further comprising a holding portion, a locking portion and an expansion portion; the holding portion attached onto one side of the locking portion opposite thereto; an outer diameter of the holding portion configured to be greater than an outer diameter of the locking portion;
an outer side of the locking portion having a plurality of locking members formed to circumference thereon; the locking portion and the expansion portion integrally formed as one piece; the expansion portion having a plurality of slots; each one of the slots extended to an end surface of the expansion portion; the shaft unit being fastened onto the inner threaded portion of the sleeve unit via the outer threaded portion thereof; the sleeve unit configured to lock onto an internal of an object via the locking members; thereby, a tool is used to fit with the flat-shape slot or the cross-shape slot in order to rotate the shaft unit such that the second end portion is driven to move toward the expansion portion of the sleeve unit, and the second end portion forces the expansion portion to expand outward in order to secure the sleeve unit inside the object.

6. The screw apparatus according to claim 5, wherein the holding portion of the sleeve unit is of a polygonal shape.

7. The screw apparatus according to claim 5, wherein the plurality of locking members of the sleeve unit are outer threads.
